(19) United States
(12) Patent Application Publication
(10) Pub. No.: US 2009/0174248 A1
(43) Pub. Date: Jul. 9, 2009

(54) Blocking system for pet toys

(76) Inventor: David Chisholm, River Edge, NJ (US)

Correspondence Address: KLAUBER & JACKSON, 411 HACKENSACK AVENUE, HACKENSACK, NJ, 07601, US

(21) Appl. No.: 12/008,247

(22) Filed: Jan. 9, 2008

(51) Int. Cl. A47B 97/00; A01K 29/00

(52) U.S. Cl. 297/463.2

(57) ABSTRACT

A blocking system for pet toys or other objects to prevent such objects from inadvertently migrating to a location beneath a piece of furniture. The system can be readily assembled on site and dimensionally conform to the footprint of a particular piece of furniture. The system includes blocking members that slidingly fit together and can be varied dimensionally both horizontally and vertically. In one embodiment, the interlocking sliding connections are accomplished by a system of dovetailed grooves.

### BACKGROUND

The present invention relates to a system for blocking pet toys or other objects from entering the space underneath a piece of furniture and, more particularly, to a system that can be readily assembled on site and be oriented under a piece of furniture to prevent pet toys or other objects from migrating underneath that furniture.

Anyone who has a pet, such as a dog or cat, knows of the problem with the migration of pet toys underneath a piece of furniture. Typically, the toy is a ball or other readily mobile object that rolls under a sofa, for example, and the pet is simply unable to retrieve the object. The pet therefore creates a disturbance in trying to retrieve the object to the point that the owner is forced to take some immediate action to relieve the pet and recover the toy.

As such, it is quite inconvenient for the owner to interrupt some other activity to assist the pet in retrieving the toy and the problem is exacerbated when the same occurrence happens numerous times during a typical day.

It would therefore be advantageous to have a system that was relatively inexpensive and which could be assembled on site and block the area underneath a piece of furniture to prevent a pet toy or other object from inadvertently rolling underneath that furniture. It would be further advantageous if the system were adjustable, both vertically and horizontally, so that it could be assembled to differing dimensions so as to fit the particular piece of furniture.

### SUMMARY OF THE INVENTION

Accordingly, the present invention relates to a barrier or blocking system that is adapted to be readily assembled so as to surround the space beneath the underside of the furniture and the floor, that is, the area where the legs are normally located supporting that furniture. The blocking system thus is provided to extend around the perimeter of the footprint of that piece of furniture so as to prevent the passage or migration of objects, such as pet toys, from entering the space underneath the piece of furniture.

With the present system, there are a plurality of blocking members that can be assembled on site and which are affixed together in a manner that the longitudinal dimension of the combined blocking system can be varied in accordance with the perimeter of the furniture footprint. As such, the present blocking system can surround, or at least partially surround, the perimeter of the footprint and yet be somewhat unobtrusive by being inset slightly behind the legs or slightly inwardly with respect to the outer perimeter of the furniture.

While the blocking system can fully surround the piece of furniture, it may be that with the piece of furniture backed up to a wall, the present system only needs to be installed around three sides of the furniture perimeter, the rear side of the furniture being inaccessible to the migration of toys.

With the present blocking system, therefore, there are various blocking members of different types that are assembled together with a sliding fit so as to enable the user to adjust the longitudinal dimension for the particular piece of furniture. In addition, there may be an upper and lower tier of blocking members that are also affixed together in a piggyback relationship so that the vertical height of the blocking system can be varied in accordance with the height of the area beneath the furniture.

With the ease of assembly and disassembly of the present blocking system, the system can be taken down, entirely or partially, for normal chores such as vacuuming underneath the piece of furniture and just a readily reassembled again after that chore has been completed.

These and other features and advantages of the present invention will become more readily apparent during the following detailed description taken in conjunction with the drawings herein.

### BRIEF DESCRIPTION OF THE DRAWINGS

FIG. 1 is a perspective view of a blocking system of the present invention assembled and installed underneath a piece of furniture;

FIGS. 2A, 2B and 2C are, respectively, a top view, a side view and a perspective view of a corner blocking member used with the present invention;

FIGS. 3A, 3B and 3C are, respectively, an end view, a side view and a perspective view of an outside blocking member used with the present invention;

FIGS. 4A, 4B and 4C are, respectively, an end view, a side view and a perspective view of a center blocking member used with the present invention;

FIGS. 5A, 5B and 5C are, respectively an end view, a side view and a perspective view of an upper blocking member used with the present invention;

FIGS. 6A and 6B are, respectively an end view and a perspective view of an assembly of outside blocking members, a center blocking member and upper blocking members of the present invention; and

FIG. 7 is a perspective view of a completed blocking system of the present invention.

### DETAILED DESCRIPTION OF THE INVENTION

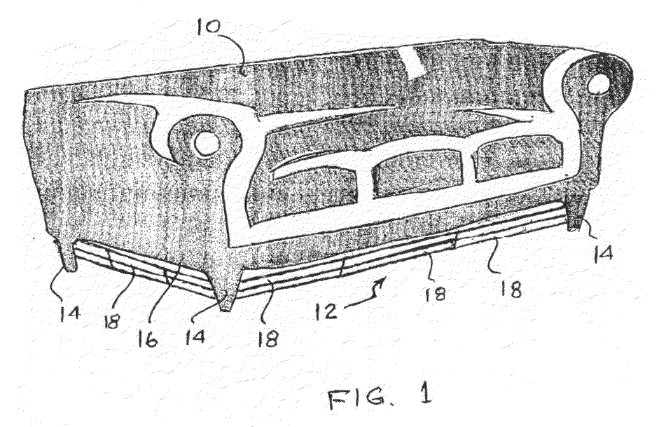

Referring now to FIG. 1, there is shown a perspective view of a piece of furniture 10, namely a sofa, to which the present blocking system 12 has been assembled and installed. As can be seen, the piece of furniture has conventional legs 14 that extend downwardly from the bottom 16 of the piece of furniture and which, of course, contact a floor to support the piece of furniture 10 thereby creating a space beneath the piece of furniture 10 having its perimeter generally the outer perimeter of the piece of furniture 10 and its height about the height of the legs 14. The perimeter of the piece of furniture 10, in the exemplary embodiment, is rectangular.

It is that space beneath the piece of furniture that needs protecting against the migration of pet toys or other objects that can inadvertently reach that space and which are then difficult and annoying to recover.

Accordingly, with the present blocking system 12, there are a plurality of blocking members 18 that effectively fill the surrounding perimeter or footprint of the piece of furniture 10 and which act to prevent the ingress of toys by blocking access to the space underneath the piece of furniture 10.

As shown in FIG. 1, only two sides of the rectangular perimeter are illustrated having the blocking system 12 installed, it being understood that the blocking system 12 can normally take up at least three sides of the rectangular perimeter or all four sides thereof.

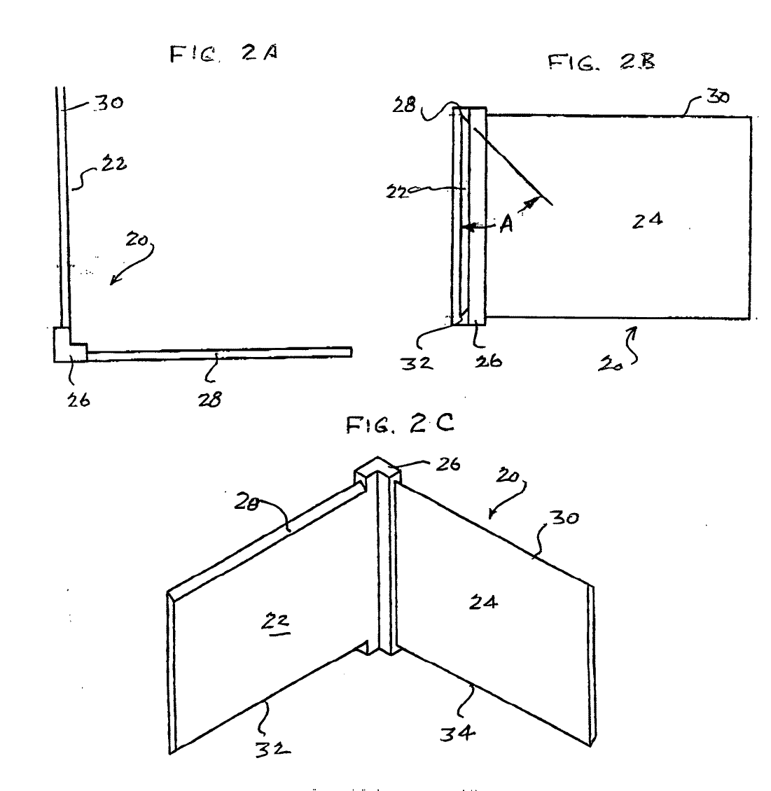

Turning now to FIGS. 2A-2C, there is shown a top view, a side view and a perspective view of a corner blocking member 20, respectively, of the present invention. As can be seen, the corner blocking member 20 comprises a pair of panels 22, 24 that extend outwardly from a junction 26 and are oriented generally about 90 degrees apart. The corner blocking member 20 as will be seen with the further blocking members to be explained, can be constructed of molded plastic material.

The panels 22, 24 each have an upper edge 28, 30 and lower edge 32, 34 having a bevel. All of the beveled upper edges 28, 30, 32 and 34 can be similar and, in the exemplary embodiment, are beveled at an angle A of about 45 degrees, thereby forming relatively sharp edges. In the exemplary embodiment of FIGS. 2A-2C, the direction of the angular bevels is in the opposite direction for the panel 22 as it is for the panel 24, that is, the sharp edges of the panel 22 are located outwardly toward the outside of the 90 degree angle while the sharp edges of the panels 24 are toward the inside 4 of the panel 24.

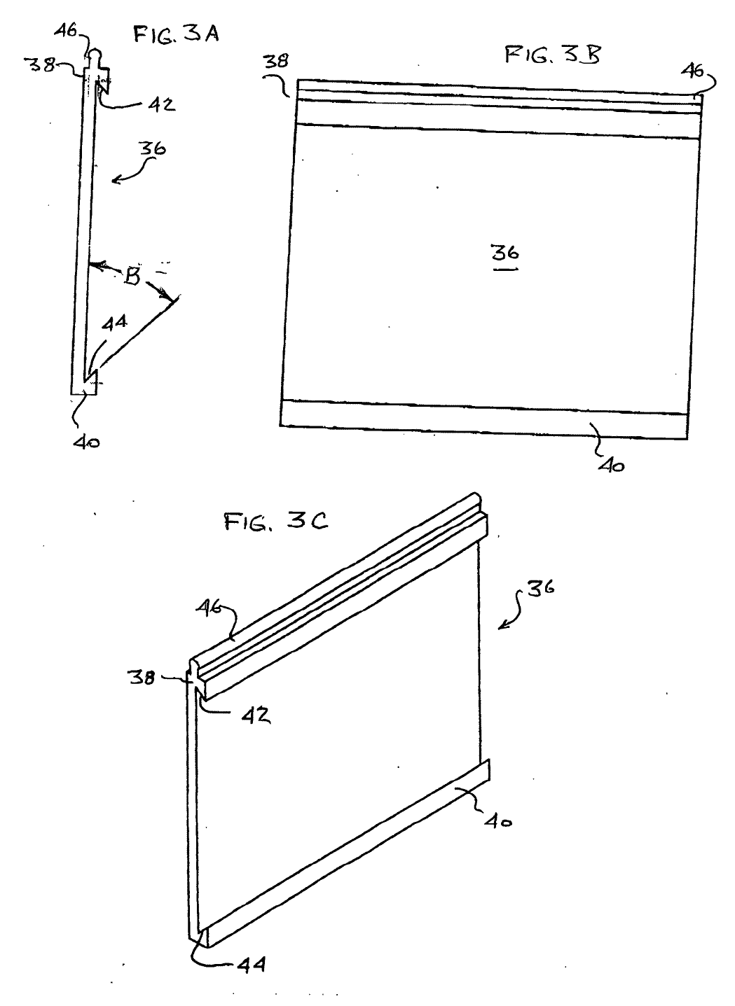

Turning now to FIGS. 3A-3C, there is shown a top view, a side view and a perspective view of an outside blocking member 36, respectively, of the present invention. The outside blocking member 36 has an upper edge 38 and a lower edge 40 and, as illustrated, there are grooves 42 and 44 formed, respectively in the upper edge 38 and the lower edge 40 on the same side of the outside locking member 36 and, in the exemplary embodiment, the groves 42, 44 are formed having an angle B of about 45 degrees. Again, the outside blocking member 36 can be formed of injected molded plastic.

There is also an upper elongated flange 46 formed along the upper edge 38 and the purpose of the upper elongated flange 46 will be later explained and, in the exemplary embodiment, the upper elongated flange 46 is shaped in a partial circular cross section.

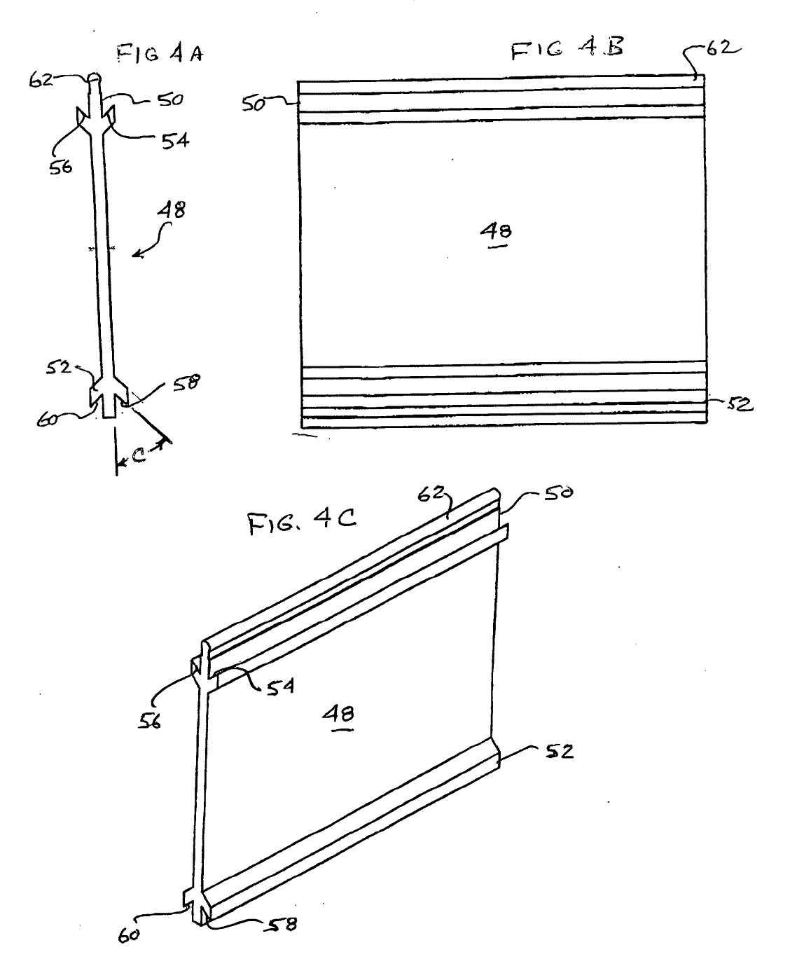

Turning now to FIGS. 4A-4C, there is shown a top view, a side view and a perspective view of a center blocking member 48, respectively, of the present invention. Accordingly, as can be seen, there is an upper edge 50 and a lower edge 52. The upper edge 50 has a pair of grooves 52, 56 formed on opposite sides of the center blocking member 48 and, in a similar manner, the lower edge 52 also has a pair of groves 58, 60 formed on opposite sides thereof. As exemplary, again, all of the grooves 52, 54, 58 and 60 can be formed at an angle C of 45 degrees. The is also an upper elongated flange 62 formed along the upper edge 52 and the purpose of the upper elongated flange 62 will be later explained and, in the exemplary embodiment, the upper elongated flange 62 is shaped in a partial circular cross section.

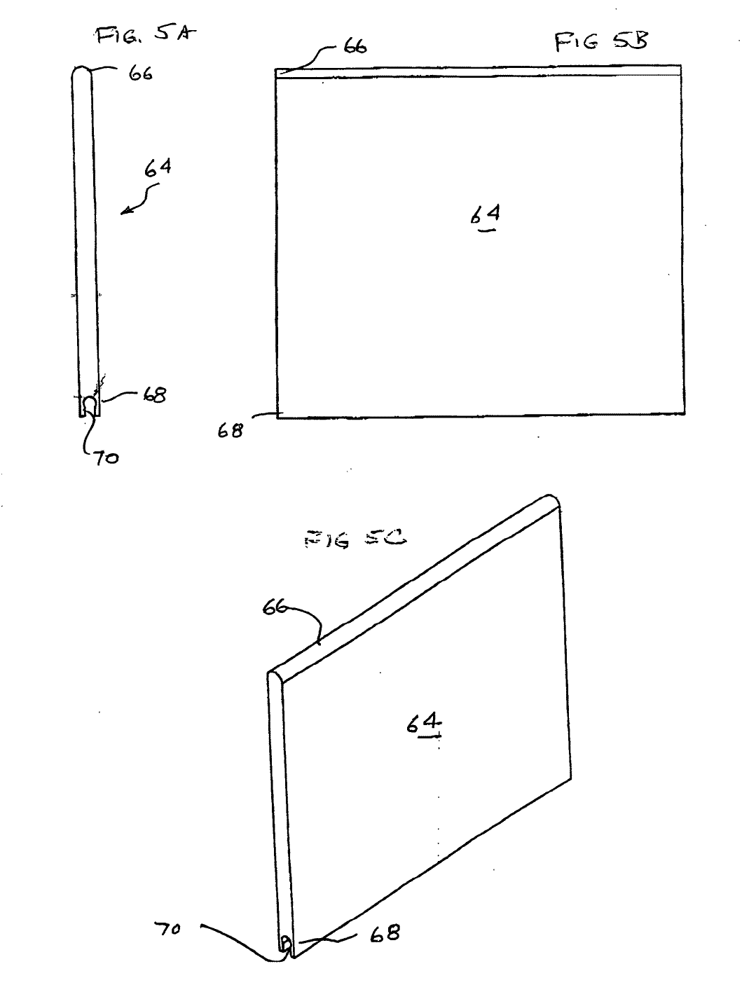

Turning now to FIGS. 5A-5C, there is shown a top view, a side view and a perspective view of an upper blocking member 64, respectively, of the present invention. As can be seen, there is an upper edge 66 that is generally rounded and a lower edge 68. There is a downwardly facing elongated lower groove 70 formed in the lower edge 68 that faces downwardly and which is a partial circular cross section to enable the upper elongated flange 46 of the outside blocking member 36 (FIGS. 3A-3C) and the upper elongated flange 62 of the center blocking member 48 (FIGS. 3A-3C) to enter into and snap into the lower groove 70 to affix the upper blocking member 64 to both the center blocking member 48 and the outside blocking member 36.

As shown, the means of attachment comprises a partial circular cross section flange that snaps into a partial circular section groove, however, it can be seen the other configurations and attachment systems could be used to secure an upper blocking member 64 to a center blocking member 48 and a outside blocking member 36.

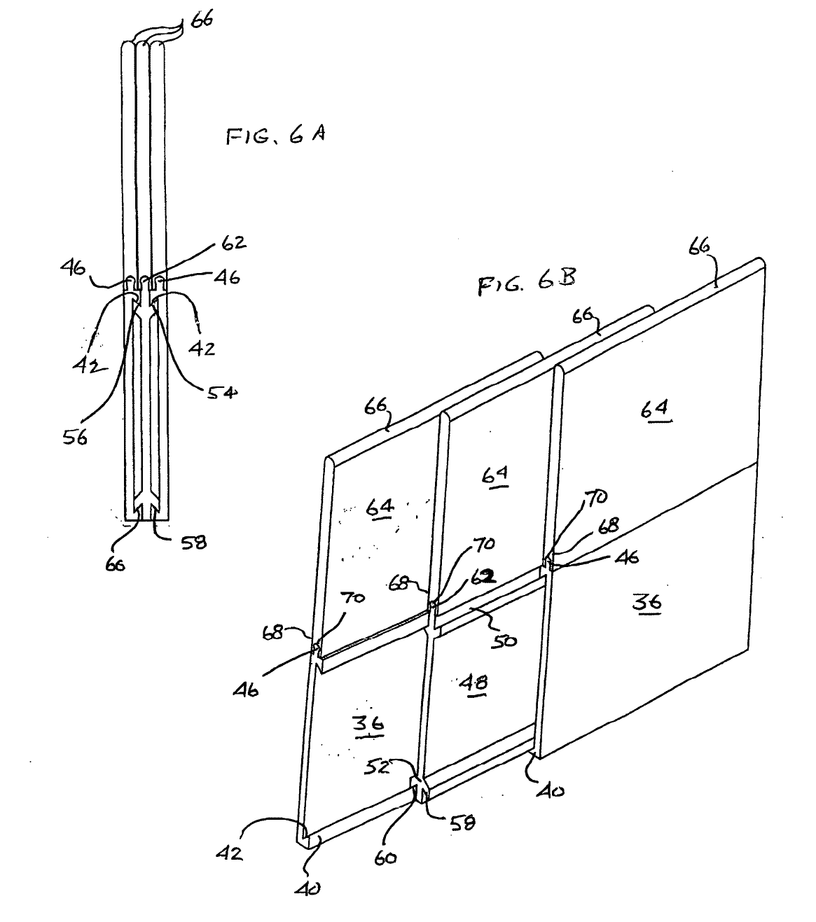

Turning now to FIGS. 6A and 6B, there is shown an end view and perspective view of outside blocking members 36, a center blocking member 48 and upper blocking members 64 of the present invention assembled together.

As can be seen, the outside blocking member 36 interfits into the center blocking member 48 by a meshing of the respective grooves, that is, the lower grooves 40, 42 of the outside blocking members 36 mesh with the grooves 58, 50 of the center blocking member 48 and the grooves 42 of the outside blocking members 36 mesh with the groves 54, 56 of the center blocking member 48 to create a dovetail arrangement wherein the respective blocking members are affixed together in a sliding relationship.

Thus, as can now be seen, by sliding the outside blocking members 36 and the center blocking members 48 longitudinally, or horizontally, the linear horizontal dimension of the assembly of blocking members can be altered to suit the particular footprint of the piece of furniture on which the present blocking system is being used.

As to the vertical dimension, as also can be seen, the upper blocking members 64 are simply snapped onto the center locking member 48 and outside locking members 36 by snapping the upper elongated flange 46 into the elongated lower groove of the upper locking members 64 to attach the upper blocking members 64 to the center blocking member 48 and the outside blocking members 36 when the user needs to add additional height to the blocking system such as when the legs of a piece of furniture are long.

Thus, for example, the center blocking member 48 and outside blocking members 36 can have a particular convenient height, such as 1.5 inches and the upper blocking members 64 also about 1.5 inches. By such example, the over height of the assembled blocking system can be 1.5 inches or 3.0 inches depending on whether the upper blocking members 62 are used or not. As such, the height of the blocking system can be adjusted in accordance with the particular height of the space underneath the piece of furniture.

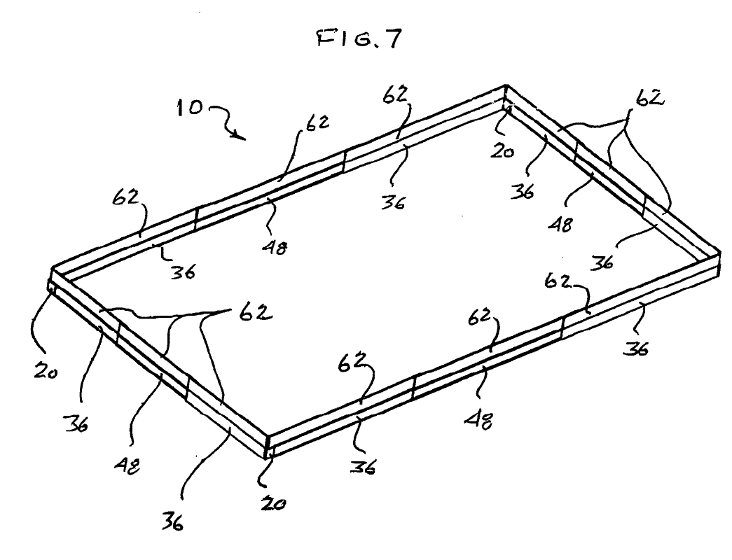

Accordingly, turning finally to FIG. 7, taken along with all of the Figs., there is shown a perspective view of a completed blocking system 10 constructed in accordance with the present invention. In assembling the completed blocking system 10, the corner locking members 20 are first positioned on the floor beneath the piece of furniture at the corners of the piece of furniture just inside the legs and the pre-assembled center blocking member 48 and outside blocking members 36 are affixed to the corner blocking members in a sliding relationship, the overall linear length being adjustable by the sliding affixation of the blocking members to carry out that task.

The blocking system is then completed, with or without the upper blocking members 62 so as to block at least three of the sides of the generally rectangular footprint of the piece of furniture, and all of the sides if the piece of furniture is positioned away from a wall such that the fourth side too is vulnerable to toys migrating therethrough.

Those skilled in the art will readily recognize numerous adaptations and modifications which can be made to the blocking system of the present invention which will result in an improved system to prevent pet toys or other objects from migrating to a location beneath a piece of furniture, yet all of which will fall within the scope and spirit of the present invention as defined in the following claims. Accordingly, the invention is to be limited only by the following claims and their equivalents.

We claim:

1. A blocking system to prevent objects from migrating to an area beneath a piece of furniture, the system comprising a plurality of blocking members assembled together to fit around the perimeter of the furniture, the blocking members being affixed together so as to be adjustable in accordance with the dimensions of the perimeter of the furniture.

2. The blocking system of claim 1 wherein the blocking members are affixed together by a system that allows dimensional changes both vertically and horizontally.

3. The blocking system of claim 1 wherein adjacent blocking members are vertically affixed together to obtain a desired vertical height of the blocking system.

4. The blocking system of claim 1 wherein the vertical affixing is provided by a system of dovetailed grooves formed on adjacent blocking members.

5. The blocking system of claim 1 wherein adjacent horizontal members are affixed a together in a sliding fit.

6. The blocking system of claim 5 wherein one blocking member has an elongated groove that dovetails with a downwardly facing groove of another blocking member to allow sliding movement therebetween.

7. The blocking system of claim 5 wherein one blocking member has a pair of parallel grooves that dovetail with downwardly facing groves of a pair of other blocking members.

8. The blocking system of claim 1 wherein the piece of furniture is rectangular and the blocking system extends at least along three sides of the rectangular perimeter.

9. The blocking system of claim 1 wherein a blocking member is comprised of two blocking surfaces joined at about a ninety degree angle.

10. A method of installing a blocking system underneath a piece of furniture having a generally rectangular perimeter, the method comprising the steps of:
providing and positioning corner blocking member at corners of the generally rectangular perimeter, the corner blocking members having blocking surfaces extending outwardly at generally a right angle;
providing and affixing generally straight blocking members to the corner blocking members to create a continual blocking surface across at least three sides of the rectangular perimeter, with adjacent straight members being slidably affixed together.

11. The method of claim 10 wherein the providing and affixing of generally straight members creates a blocking surface across all four sides of the rectangular perimeter.

12. The method of claim 10 wherein the method includes providing and affixing a blocking member atop of another blocking member to increase the vertical height of the blocking system.

13. The method of claim 12 wherein the affixing of a blocking member atop of another blocking member comprises dovetailing of grooves of the blocking members.

14. The method of claim 10 wherein the affixing of generally straight members comprises affixing the generally straight members with a sliding affixation to provide an adjustable horizontal dimension.

15. The method of claim 14 wherein the affixing of generally straight members comprises affixing the generally straight members with a sliding affixation by means of interfitting a dovetail interfitting of grooves.

16. The method of claim 10 wherein the method includes the step of sliding one straight member with respect to an adjacent straight member to make the linear horizontal dimension of one blocking surface about the same as one side of the rectangular perimeter.

17. A combination of a piece of furniture and a blocking system, the piece of furniture having a bottom and having legs extending downwardly from the bottom to contact a floor creating a space underneath the piece of furniture, the blocking system comprising a plurality of interconnected blocking members that are located beneath the piece of furniture and which block the perimeter of the piece of furniture extending from the bottom of the piece of furniture to a floor to prevent objects from migrating to the space underneath the piece of furniture.

18. The combination as defined in claim 17 wherein adjacent blocking members are interconnected together by a horizontal sliding fit.

19. The combination as defined in claim 17 wherein the blocking system includes vertically oriented interconnected blocking members.

20. The combination as defined in claim 17 wherein the horizontal sliding fit is created by the interfitting of a groove of one blocking member into a groove of another blocking member.
